(19) United States
(12) Patent Application Publication
(10) Pub. No.: US 2011/0045177 A1
(43) Pub. Date: Feb. 24, 2011

(54) PROCESS FOR PRODUCTION OF LIGHT-DIFFUSING FILMS

(75) Inventors: Akinori Nishimura, Osaka (JP); Minoru Miyatake, Osaka (JP); Hideyuki Yonezawa, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/921,484

(22) PCT Filed: Jan. 14, 2009
(86) PCT No.: PCT/JP2009/050339

§ 371 Date: Nov. 1, 2010

(30) Foreign Application Priority Data
Mar. 11, 2008 (JP) 2008-060601
Dec. 25, 2008 (JP) 2008-329051

(51) Int. Cl. B05D 5/06

(52) U.S. Cl. 427/164

(57) ABSTRACT

There is provided a process for production of a light-diffusing film 10 including a plurality of short fibers 11 and a transparent resin 12 for binding the short fibers 11 to each other. The production process of the present invention includes a step A of converting the plurality of short fibers 11 into a prefilm by a paper-making process, and a step B of coating a coating solution capable of forming the transparent resin 12 on at least one surface of the prefilm obtained in the step A, and solidifying or curing the coating solution coated on the prefilm to form a light-diffusing film 10. This production process can increase productivity of the light-diffusing film 10 since a production rate of the prefilm is higher than that of a conventional production process.

### BACKGROUND OF THE INVENTION

1. Field of the Invention

The present invention relates to a process for production of a light-diffusing film in which a plurality of short fibers are bound with a transparent resin.

2. Description of Related Art

A light-diffusing film is used in various displays for the purpose of making intensity distribution of light from a light source uniform and removing unevenness of brightness of a screen. Conventionally, there has been known, as a light-diffusing film, those obtained by coating an acrylic resin on a woven fabric produced by using polyester yarns (see, for example, Japanese Unexamined Patent Publication No. JP 09-304602 A). However, such a process for production of a light-diffusing film had a problem that since it is necessary to interweave warp yarns and weft yarns, a long time is required to produce a woven fabric, resulting in low productivity. Therefore, there has been required a process for production of a light-diffusing film, which has overcome the above problems and is excellent in productivity.

### SUMMARY OF THE INVENTION

A conventional process for production of a light-diffusing film requires a long time to produce a woven fabric and is inferior in productivity, and thus an object of the present invention is to realize a process for production of a light-diffusing film which is excellent in productivity.

As a result of a study of the present inventors, a process for production of a light-diffusing film with high productivity has been realized by a process of converting a plurality of short fibers into a prefilm using a paper-making process. In the present description, an assembly of the plurality of short fibers obtained, for example, by a paper-making process refers to a prefilm in a sense of a prestage of a light-diffusing film.

The summary of the present invention is as follows.

In a first preferred embodiment, a process for production of a light-diffusing film according to the present invention is a process for production of a light-diffusing film including a plurality of short fibers and a transparent resin for binding the short fibers to each other, the process includes a step A of converting the plurality of short fibers into a prefilm by a paper-making process, and a step B of coating a coating solution capable of forming the transparent resin through solidification or curing on at least one surface of the prefilm obtained in the step A, and solidifying or curing the coating solution coated on the prefilm to form a light-diffusing film.

In a second preferred embodiment of the process for production of a light-diffusing film according to the present invention, the short fibers have a length of 0.2 mm to 15 mm.

In a third preferred embodiment of the process for production of a light-diffusing film according to the present invention, the transparent resin is an optically isotropic resin.

In a fourth preferred embodiment of the process for production of a light-diffusing film according to the present invention, a relation between an average refractive index n₁ of the short fibers and an average refractive index n₀ of the transparent resin satisfies the following inequality:

0.01≦|n₁−n₀|≦0.15

where the average refractive index n₁ of the short fibers satisfies the following equation:

n₁=(refractive index in the major axis direction+2×refractive index in the minor axis direction)/3, and the average refractive index n₀ of the transparent resin satisfies the following equation:

n₀=(refractive index to extraordinary light+2×refractive index to ordinary light)/3. The minor axis refers to an axis which passes through the center of gravity of the short fibers, and intersects perpendicularly to the major axis.

In a fifth preferred embodiment of the process for production of a light-diffusing film according to the present invention, the short fibers include a first refractive index region having the major axis and the minor axis, and a second refractive index region having the major axis and the minor axis, which is included inside the first refractive index region and has a refractive index different from that of the first refractive index region. The minor axis refers to an axis which passes through the center of gravity of the first refractive index region or the second refractive index region, and intersects perpendicularly to the major axis of the region.

In a sixth preferred embodiment of the process for production of a light-diffusing film according to the present invention, two or more second refractive index regions are included inside the first refractive index region of the short fibers.

In a seventh preferred embodiment of the process for production of a light-diffusing film according to the present invention, a relation among the average refractive index n₀ of the transparent resin, an average refractive index n_{A} of the first refractive index region and average refractive index n_{B} of the second refractive index region of the short fibers satisfies the following inequality:

n₀<n_{A}<n_{B}, or n_{B}<n_{A}<n₀

where the average refractive index n_{A} of the first refractive index region of the short fibers satisfies the following equation:

n_{A}=(refractive index in the major axis direction+2×refractive index in the minor axis direction)/3, the average refractive index n_{B} of the second refractive index region satisfies the following equation:

n_{B}=(refractive index in the major axis direction+2×refractive index in the minor axis direction)/3, and the average refractive index n₀ of the transparent resin satisfies the following equation:

n₀=(refractive index to extraordinary light+2×refractive index to ordinary light)/3.

In an eighth preferred embodiment of the process for production of a light-diffusing film according to the present invention, a relation among the average refractive index n₀ of the transparent resin, the average refractive index n_{A} of the first refractive index region and average refractive index n_{B} of the second refractive index region of the short fibers satisfies the following inequality:

0.3≦|n_{A}−n₀|/|n_{B}−n₀|≦0.7.

In a ninth preferred embodiment of the process for production of a light-diffusing film according to the present invention, a relation between the average refractive index n₀ of the transparent resin and the average refractive index n_{B} of the second refractive index region of the short fibers satisfies the following inequality:

0.01≦|n_{B}−n₀|≦0.15.

In a tenth preferred embodiment of the process for production of a light-diffusing film according to the present invention, the first refractive index region of the short fibers is composed of an olefin polymer, and the second refractive index region is composed of a vinyl alcohol-based polymer.

In an eleventh preferred embodiment of the process for production of a light-diffusing film according to the present invention, the transparent resin is an ultraviolet-curable resin.

### ADVANTAGE OF THE INVENTION

According to the present invention, a process for production of a light-diffusing film with high productivity has been realized.

### DESCRIPTION OF THE PREFERRED EMBODIMENTS

The present inventors have intensively studied so as to solve the above problems, thus making it possible to increase productivity of a light-diffusing film by employing a production process of converting a plurality of short fibers into a prefilm by a paper-making process in place of a process of weaving long fibers which was the cause of reduction in productivity in a conventional production process. In the conventional production process, even if the insertion rate of weft yarns is 1,000 yarns/minute, the production rate of a woven fabric is only about 0.5 m/minute. However, according to the production process of the present invention, it is possible to increase the production rate to several m/minute to several tens m/minute, thus obtaining productivity which is several tens to several hundreds times higher than that of a conventional production process.

### [Production Process of the Present Invention]

The present invention is directed to a process for production of a light-diffusing film including a plurality of short fibers, and a transparent resin for binding the short fibers to each other. The production process of the present invention includes a step A of converting the plurality of short fibers into a prefilm by a paper-making process, and a step B of coating a coating solution capable of forming the transparent resin through solidification or curing on at least one surface of the prefilm obtained in the step A, and solidifying or curing the coating solution coated on the prefilm to form a light-diffusing film. According to this production process, the production rate of a prefilm is significantly high, which is by far larger than that of a conventional production process, thus making it possible to remarkably increase productivity of the light-diffusing film.

The production process of the present invention may include any other step as long as it includes the above steps A and B. The other step includes, for example, a step of interlacing short fibers with each other by a waterjet process, a step of fixing short fibers with each other using a sizing agent, and a step of drying a prefilm.

### [Step A]

The step A of the present invention is converting a plurality of short fibers into a prefilm by a paper-making process. The length of the short fiber is preferably from 0.2 mm to 15 mm, more preferably from 0.5 mm to 10 mm, and still more preferably from 1 mm to 8 mm. When the length of the short fiber is within the above range, the plurality of short fibers can be efficiently formed into a sheet shape by a paper-making process and a prefilm having excellent mechanical strength can be obtained. The short fibers can be obtained, for example, by cutting spun long fibers into a predetermined length. The diameter of the short fiber is preferably from 1 μm to 50 μm, and more preferably from 2 μm to 30 μm.

There are no particular limitations on the material from which short fibers are formed, and any material having excellent transparency can be employed. Examples of the material to be used include an olefin-based polymer, a vinyl alcohol-based polymer, a (meth)acrylic polymer, an ester-based polymer, a styrene-based polymer, an imide-based polymer, an amide-based polymer, a liquid crystal polymer, and a blend polymer thereof. Of these materials, an olefin-based polymer having high flexibility and excellent workability, a vinyl alcohol-based polymer, and a blend polymer thereof can be preferably used.

The absolute value |n₁−n₀| of a difference between an average refractive index n₁ of short fibers and an average refractive index n₀ of a transparent resin is preferably 0.01 or more, and more preferably from 0.01 to 0.15. Accordingly, it is possible to obtain output light having wide diffusion properties and to inhibit backscattering at the same time. The average refractive index n₁ of the short fibers can be appropriately increased or decreased by changing the kind and/or the content of organic groups to be introduced into a resin. For example, the average refractive index n₁ of the short fibers can be increased by introducing cyclic aromatic groups (phenyl group, etc.) into the short fibers. In contrast, the average refractive index n₁ of the short fibers can be decreased by introducing aliphatic groups (methyl group, etc.) into the short fibers.

The paper-making process to be used in the present invention is not particularly limited, and may be a hand paper-making process or a mechanical paper-making process. The paper-making process is preferably a mechanical paper-making process using any paper machine, which is excellent in a production rate. The paper machine includes, for example, a cylinder paper machine, a short-net paper machine and a long-net paper machine.

The step A preferably includes a step a1 of casting a slurry for paper-making prepared by dispersing a plurality of short fibers in water over a net, sticking the short fibers in the slurry onto the surface of the net while removing water in the slurry from a mesh to obtain a paper-making web, and a step a2 of drying the paper-making web obtained in the step a1 to obtain a prefilm. The paper-making web is in the form of a sheet of the short fibers in a state of containing moisture.

Usually, the paper-making web contains much moisture, and therefore it can be formed into a prefilm by placing on a blanket and squeezing water, or placing on a cylinder dryer (circular dry cylinder) and drying. The basis weight of the paper-making web is preferably from 10 g/m² to 1,000 g/m².

The slurry for paper-making is not particularly limited as long as it contains a plurality of short fibers, and may contain any additives. Examples of the additives include ultraviolet absorbers, surfactants, sizing agents and binder fibers.

### [Step B]

The step B of the present invention is coating a coating solution capable of forming a transparent resin through solidification or curing, on at least one surface of the prefilm obtained in the step A, and solidifying or curing the coating solution coated on the prefilm to form a light-diffusing film.

The coating solution is not particularly limited as long as it can form a transparent resin and is prepared, for example, by dispersing or dissolving a transparent resin in a solvent.

In the present invention, the “transparent resin” refers to a resin having a transmittance of 80% or more at a wavelength of 546 nm. The transparent resin to be used in the present invention is formed from any material which binds short fibers to each other and is excellent in transparency. Examples of the material from which the transparent resin is formed include an ultraviolet-curable resin, a cellulose-based polymer and a norbornene-based polymer. The transparent resin is preferably an energy-curable resin, and particularly preferably an ultraviolet-curable resin. The ultraviolet-curable resin has high productivity since it can form a film at a high rate.

The average refractive index n₀ of the transparent resin is preferably from 1.3 to 1.7, and more preferably from 1.4 to 1.6. The average refractive index n₀ of the transparent resin can be appropriately increased or decreased by changing the kind and/or the content of organic groups to be introduced into a resin. For example, the average refractive index n₀ of the transparent resin can be increased by introducing cyclic aromatic groups (phenyl group, etc.) into the transparent resin. In contrast, the average refractive index n₀ of the transparent resin can be decreased by introducing aliphatic groups (methyl group, etc.) into the transparent resin.

The transparent resin to be used in the present invention is preferably an optically isotropic resin having small refractive index anisotropy. In the present invention, the “optically isotropic resin” refers to a resin having birefringence (difference between a refractive index in a direction which exhibits a maximum refractive index and a refractive index in a direction which exhibits a minimum refractive index) of less than 0.001. The amount of the transparent resin to be used is preferably from 10 parts by weight to 500 parts by weight with respect to 100 parts by weight of the short fibers.

There are no particular limitations on a process of coating a coating solution capable of forming a transparent resin on the surface of a prefilm, and a coating process using any coater, or a dipping process is used. Examples of the coater include a slot orifice coater, a die coater, a bar coater and a curtain coater.

The surface of the prefilm to be coated with the coating solution is not particularly limited and may be one or both surfaces. The coated region may be formed so as to embed a plurality of short fibers, or formed so as to bind a part of the plurality of short fibers to each other.

In the step B, the coated region is solidified or cured by any process. In the present description, “solidification” refers to a state where a softened or melted resin (polymer) is solidified by cooling, or a state where a resin (polymer) in the form of a solution due to dissolution in a solvent is solidified by removing the solvent. “Curing” refers to a state where a resin becomes hardly soluble or hardly meltable as a result of crosslinking through heat, catalyst, light or radiation. The conditions of solidification or curing are appropriately determined according to the kind of the transparent resin to be used. When an ultraviolet-curable resin is used as the transparent resin, regarding the curing conditions, illuminance of ultraviolet radiation is preferably from 5 mW/cm² to 1,000 mW/cm², and an integrated light quantity is preferably from 100 mJ/cm² to 5,000 mJ/cm².

### [Light-Diffusing Film]

In FIG. 1, a schematic plan view of a light-diffusing film 10 obtained by the production process of the present invention is shown. The light-diffusing film 10 obtained by the production process of the present invention is provided with a plurality of short fibers 11, and a transparent resin 12 for binding the short fibers 11 to each other. The thickness of the light-diffusing film 10 is preferably from 5 μm to 200 μm.

In the light-diffusing film 10, the plurality of short fibers 11 may be oriented as being biased in a specific direction, or may not be oriented as being biased (non-orientation). When the short fibers 11 are oriented as being biased in a specific direction, the light-diffusing film 10 exhibits directive diffusion properties, while it exhibits diffusion properties in the whole direction in the case of non-orientation.

When the average refractive index n₁ of the short fibers 11 is different from the average refractive index n₀ of the transparent resin 12, the light-diffusing film 10 enables emission of incident light while diffusing in a wide range. The absolute value |n₁−n₀| of a difference between the average refractive index n₁ of the short fibers 11 and the average refractive index n₀ of the transparent resin 12 is preferably 0.01 or more, and more preferably from 0.01 to 0.15. Accordingly, it is possible to obtain output light having wide diffusion properties and to inhibit backscattering at the same time.

In one embodiment, the short fibers include a first refractive index region and a second refractive index region, each having the major axis and the minor axis. The minor axis refers to an axis which passes through the center of gravity of each refractive index region, and intersects perpendicularly to the major axis. The second refractive index region is present inside the first refractive index region, and is composed of a material having a refractive index which is different from that of the first refractive index region. Since the light-diffusing film with this constitution can reduce a difference in the refractive index between the respective members, reflection occurred at the interface between the respective members is inhibited, thus making it possible to reduce backscattering.

FIG. 2(a) is a schematic view showing an example of a short fiber 20 having a single structure composed only one kind of a refractive index region used in the present invention. FIG. 2(b) and FIG. 2(c) are schematic views showing examples of short fibers 30, 40, each having two kinds of refractive index regions used in the present invention.

FIG. 2(b) is a view showing an example of a short fiber 30 having a so-called core-sheath structure which includes a single second refractive index region 32 inside a first refractive index region 31. FIG. 2(c) is a view showing a short fiber 40 having a so-called sea-island structure which includes two or more second refractive index regions 42 inside a first refractive index region 41.

While FIG. 2(b) and FIG. 2(c) show examples in which the short fibers 30, 40 are composed of only first and second refractive index regions, the short fibers to be used in the present invention may include a third refractive index region or an optical isotropic region which is composed of any material (not shown).

In FIG. 2(b) and FIG. 2(c), the second refractive index regions 32, 42 have a columnar shape. However, the shape of the second refractive index regions 32, 42 may be polygonal prism such as triangular prism or quadrangular prism, and may be any shape. Furthermore, the second refractive index regions 32, 42 may not be uniformly distributed inside the first refractive index regions 31, 41, and may be present as being biased.

A relation among an average refractive index n_{A} of the first refractive index regions 31, 41 and average refractive index n_{B} of second refractive index regions 32, 42 of the short fibers, and an average refractive index n₀ of the transparent resin 12 preferably satisfies the following inequality:

n₀<n_{A}<n_{B}, or n_{B}<n_{A}<n₀.

As described above, the light-diffusing film whose refractive index varies stepwise has such a feature that interface reflection occurred at the interface between the transparent resin 12 and the short fibers 11 can be reduced, resulting in small backscattering due to decreasing of a difference in a refractive index at the interface between the respective members.

In order to reduce backscattering, the average refractive index n_{A} of the first refractive index regions 31, 41 is preferably an intermediate value of the average refractive index n₀ of the transparent resin 12 and the average refractive index n_{B} of the second refractive index regions 32, 42. This is represented by the following inequality:

0.3≦|n_{A}−n₀|/|n_{B}−n₀|≦0.7.

In view of obtaining output light having wide diffusion properties and inhibiting backscattering at the same time, a relation between the average refractive index n_{B} of the second refractive index regions 32,42 and the average refractive index n₀ of the transparent resin 12 preferably satisfies the following inequality:

0.01≦|n_{B}−n₀|≦0.15.

### [Applications of Light-Diffusing Film]

The light-diffusing film of the present invention is suitably used, for example, in liquid crystal panels of computers, copying machines, mobile phones, clocks, digital cameras, personal digital assistants, portable game machines, video cameras, televisions, microwave ovens, car navigations, car audios, store monitors, surveillance monitors and medical monitors.

As one of preferred applications of the light-diffusing film of the present invention, a depolarizing element is exemplified. The depolarizing element is disposed, for example, on the outermost surface of a liquid crystal display, thus making it possible to visibility of users wearing polarized sunglasses.

When used as the depolarizing element, Haze of the light-diffusing film is preferably from 10% to 80%. The length of short fiber contained in the light-diffusing film is preferably from 0.2 mm to 10 mm, and the absolute value |n₁−n₀| of a difference between an average refractive index n₁ of short fibers and an average refractive index n₀ of a transparent resin is preferably 0.03 or less.

With such a design, even when users wear polarized sunglasses, it is possible to obtain a liquid crystal display which enables satisfactory visibility similarly to a case where users wear no polarized sunglasses.

### EXAMPLES

### Example 1

An ethylene vinyl alcohol copolymer (produced by Nippon Synthetic Chemical Industry Co., Ltd. Product Name: “Soarnol DC321B,” melting point: 181° C.) was fused at 270° C. and then was charged into a nozzle for single-structure fiber spinning to obtain a spinning filament with a diameter of 30 μm by spinning the copolymer at a spinning rate of 600 m/minute. This spinning filament was stretched 4 times as long as the original length in warm water at 60° C. to obtain fibers with a diameter of 15 μm.

The aforementioned long fibers were cut to the length of 5 mm to form short fibers. A plurality of the short fibers were prepared. And then the fibers were dispersed in water and stirred to obtain a uniform slurry for paper-making. Subsequently, the slurry for paper-making was cast by flowing on a metal-mesh of a cylinder paper machine and then the short fibers were adhered to a metal-mesh surface to obtain a sheet making web with a basis weight of 40 g/m² and a width of 25 cm. Next, the sheet making web was placed on a blanket to squeeze water with a roll and placed on a cylinder dryer to be dried to obtain a prefilm with a thickness of 35 μm. The production rate of the prefilm was then 10 m/minute.

As an optically isotropic transparent resin, a polyester acrylate-base ultraviolet-curable resin (produced by Sartomer Company Inc., Product Name: “CN2273) was coated on one surface of the aforementioned prefilm in such a manner that the prefilm was embedded. Subsequently, ultraviolet rays were irradiated (illuminance=40 mW/cm², amount of integrating light: 1,000 mJ/cm²) and then the ultraviolet-curable resin was cured to prepare a light-diffusing film with a thickness of 150 μm. The amount used of the ultraviolet-curable resin was 100 weight parts with respect to the total amount of 100 weight parts of fibers. The average refractive index of each component of the light-diffusing film and diffusing characteristics of output light were as shown in Table 1.

### Example 2

An ethylene vinyl alcohol copolymer (produced by Nippon Synthetic Chemical Industry Co., Ltd. Product Name: “Soarnol DC321B,” melting point: 181° C.) and an ethylene propylene copolymer of excessive propylene (produced by Japan Polypropylene Corporation, Product Name “OX1066A”, melting point: 138° C.) were respectively fused at 270° C. and 230° C. and then were charged into a nozzle for sea-island composite fiber spinning (island number per fiber cross section: 37) to obtain a spinning filament with a diameter of 30 μm by spinning these copolymers at a spinning rate of 600 m/minute.

This spinning filament was stretched 4 times as long as the original length in warm water at 60° C. to obtain fibers with a diameter of 15 μm. When the cross section surfaces of the fibers were observed with an electron microscope, it was confirmed that a sea-island structure was configured wherein a columnar (diameter of its cross section: approximately 1 μm) second refractive index region (island portion) composed of an ethylene vinyl alcohol copolymer was distributed inside a columnar (diameter of its cross section: 15 μm) first refractive index region (sea portion) composed of an ethylene propylene copolymer.

The aforementioned long fibers were cut to the length of 5 mm to form short fibers. And a light-diffusing film was prepared in the same manner as in Example 1 in a later step. The average refractive index of each component of the light-diffusing film and the diffusing characteristics of the output light were as shown in Table 1.

TABLE 1

| | | Average | | |
|---|---|---|---|---|
| | Average | Refractive Index | Light Diffusing Film | |
| | Refractive Index | of Transparent | | Back- |
| | of short fibers | resin | Haze | scattering |
| Example 1 | n₁ = 1.54 | n₀ = 1.48 | 80% | Large |
| Example 2 | Sea portion | n₀ = 1.48 | 80% | Small |
| | n_{A} = 1.50 | | | |
| | Island portion | | | |
| | n_{B} = 1.54 | | | |

### [Assessment]

In a conventional process for production of a light-diffusing film for producing a woven fabric by interweaving warp yarns and weft yarns, even if the insertion rate of weft yarns is 1,000 yarns/minute, the production rate of a woven fabric is only 0.5 m/minute or so. Since the production rate of a prefilm is 10 m/minute in an Example of the present invention, the process for production of light-diffusing films in the present invention makes it possible to obtain a production rate twenty times as fast as that of a conventional production process.

Comparing the light-diffusing film having a single structure such as Example 1 to the light-diffusing film having a sea-island structure such as Example 2, the film of Example 2 is more superior as a light-diffusing film because the haze of both films is equivalent, however, the sea-island structured film has less backscattering.

### [Measuring Method]

### [Haze]

Haze was measured using a haze meter (produced by MURAKAMI COLOR RESEARCH LABORATORY, product name: “HM-150” in accordance with JIS K 7136:2000.

### [Average Refractive Index of Fibers]

A refractive index at room temperature (25° C.) and at the wavelengths of 546 nm was measured by the Becke's line method using a polarization microscope produced by Olympus Corporation.

### [Refractive Index of Transparent Resin]

A refractive index at room temperature (25° C.) and at the wavelengths of 546 nm was measured using a prism coupler produced by Sairon Technology Ltd.

### [Backscattering]

A black acrylic board was adhered to the back of a light-diffusing film and a surface of the light-diffusing film was illuminated by a white fluorescent lamp to visually observe the intensity of reflected light.

### BRIEF DESCRIPTION OF THE DRAWINGS

FIG. 1 is a schematic plan view of a light-diffusing film.

FIG. 2 (a) to FIG. 2 (c) are respectively a schematic view of short fibers to be used in the present invention.

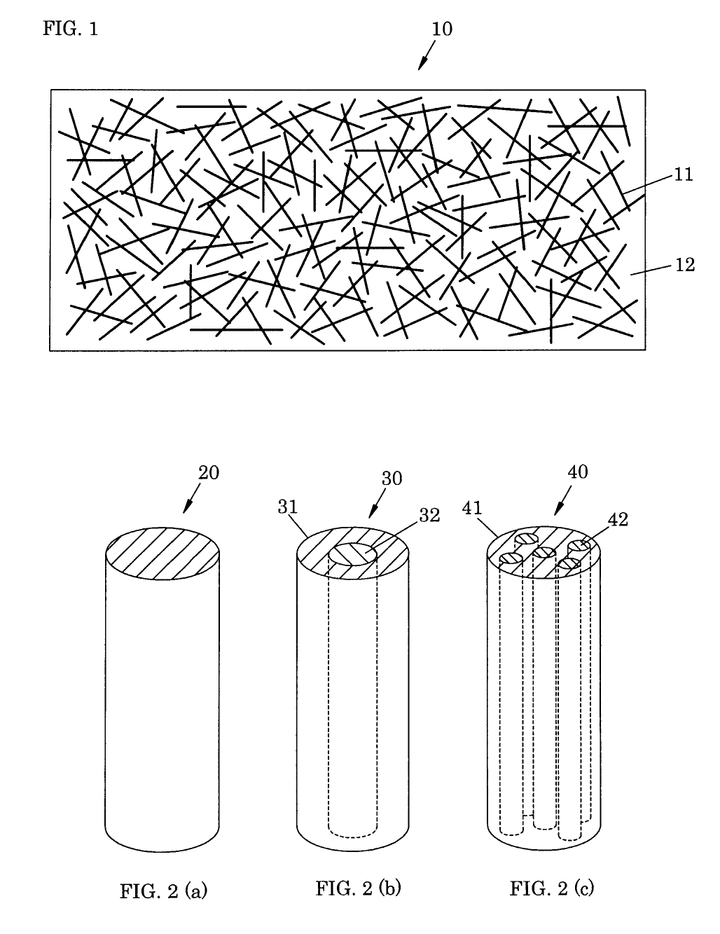

### DESCRIPTION OF THE SYMBOLS

10: light-diffusing film, 11: short fiber, 12: transparent resin, 20: short fiber having a single structure, 30: short fiber having a core-sheath structure, 31: first refractive index region, 32: second refractive index region, 40: short fiber having a sea-island structure, 41: first refractive index region, 42: second refractive index region

What is claimed is:

1. A process for production of a light-diffusing film including a plurality of short fibers and a transparent resin for binding the short fibers to each other, comprising the steps of:
A) converting the plurality of short fibers into a prefilm by a paper-making process; and
B) coating a coating solution capable of forming the transparent resin through solidification or curing on at least one surface of the prefilm obtained in the step A, and solidifying or curing the coating solution coated on the prefilm to form a light-diffusing film.

2. The process according to claim 1, wherein the short fibers have a length of 0.2 mm to 15 mm.

3. The process according to claim 1 or claim 2, wherein the transparent resin is an optically isotropic resin.

4. The process according to claim 3, wherein a relation between an average refractive index n₁ of the short fibers and an average refractive index n₀ of the transparent resin satisfies the following inequality:
0.01≦|n₁−n₀|≦0.15
where the average refractive index n₁ of the short fibers satisfies the following equation:
n₁=(refractive index in the major axis direction+2×refractive index in the minor axis direction)/3, and the average refractive index n₀ of the transparent resin satisfies the following equation:
n₀=(refractive index to extraordinary light+2×refractive index to ordinary light)/3.

5. The process according to claim 3, wherein the short fibers include a first refractive index region having the major axis and the minor axis, and a second refractive index region having the major axis and the minor axis, which is included inside the first refractive index region and has a refractive index different from that of the first refractive index region.

6. The process according to claim 5, wherein two or more second refractive index regions are included inside the first refractive index region of the short fibers.

7. The process according to claim 5, wherein a relation among the average refractive index n₀ of the transparent resin, an average refractive index n_{A} of the first refractive index region and average refractive index n_{B} of the second refractive index region of the short fibers satisfies the following inequality:
n₀<n_{A}<n_{B}, or n_{B}<n_{A}<n₀
where the average refractive index n_{A} of the first refractive index region of the short fibers satisfies the following equation:
n_{A}=(refractive index in the major axis direction+2×refractive index in the minor axis direction)/3, the average refractive index n_{B} of the second refractive index region satisfies the following equation:
n_{B}=(refractive index in the major axis direction+2×refractive index in the minor axis direction)/3, and the average refractive index n₀ of the transparent resin satisfies the following equation:
n₀=(refractive index to extraordinary light+2×refractive index to ordinary light)/3.

8. The process according to claim 7, wherein a relation among the average refractive index n₀ of the transparent resin, the average refractive index n_{A} of the first refractive index region and average refractive index n_{B} of the second refractive index region of the short fibers satisfies the following inequality:
0.3≦|n_{A}−n₀|/|n_{B}−n₀|≦0.7.

9. The process according to claim 5, wherein a relation between the average refractive index n₀ of the transparent resin and the average refractive index n_{B} of the second refractive index region of the short fibers satisfies the following inequality:
0.01≦|n_{B}−n₀|≦0.15.

10. The process according to claim 5, wherein the first refractive index region of the short fibers is composed of an olefin polymer, and the second refractive index region is composed of a vinyl alcohol-based polymer.

11. The process according to claim 1, wherein the transparent resin is an ultraviolet-curable resin.
